(19) United States
(12) Patent Application Publication
(10) Pub. No.: US 2016/0314427 A1
(43) Pub. Date: Oct. 27, 2016

(54) DATABASE, INTERFACE, AND METHOD FOR PERSONALIZED, SKILL-SET BASED CRM ENGAGEMENT

(71) Applicant: salesforce.com, inc., San Francisco, CA (US)

(72) Inventor: John Michael Brunswick, Boston, MA (US)

(73) Assignee: salesforce.com, inc., San Francisco, CA (US)

(21) Appl. No.: 14/697,529

(22) Filed: Apr. 27, 2015

(51) Int. Cl. G06Q 10/06; G06F 17/30; G06Q 50/20

(52) U.S. Cl. CPC G06Q 10/063112; G06Q 50/2057; G06F 17/30525

(57) ABSTRACT

The technology disclosed relates to providing skill-based access control to a set of sales and service opportunities. Specifically, skill-based criteria attributes secure opportunity records each relating to a particular product or service. Each skill-based criteria attribute corresponds to one or more skill-based credentials that a user must have to qualify the user to sell or service the particular product or service. The technology disclosed further relates to user records that provide one or more skill-based credentials acquired by a user for selling or servicing products or services. In response to receiving a query from the user, retrieved opportunity records are qualified by applying the skill-based criteria attributes to the user's skill-based credentials. Only data from the qualified opportunity records are transmitted in response to the query. User acquisition of additional credentials may result in access to opportunities that were previous inaccessible to the user.

### BACKGROUND

This application relates to improvements in organizing and inter-relating data files that implement personalized, skill-set based engagement between opportunities and workers. The technology described leverages data processing security in online environments on a personal skill-set basis.

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

A organization may be concerned with an optimal assignment of opportunities to workers, with the belief that pursuing an opportunity will be most successful when the assigned worker is knowledgeable regarding the product or service involved. Customer interaction enablement/knowledge management database systems may be used. In addition, certification processes around various product and service offerings may also be used. However, these solutions have limited effectiveness because they are not integrated with modern online customer relation management (CRM) database tools that actually assign leads or opportunities. Even when interaction enablement tools have integration points into CRM tools, the use of such tools is siloed (i.e., separate) rather than an integral part of the opportunity assignment process. For example, an interaction enablement tool may be intended for use after a worker has already been assigned an opportunity for which they are not prepared to be effective, and using the identified tool may be voluntary and left to the discretion of the worker. As a result, assignment of opportunities to workers does not consider skills and knowledge already acquired by the worker. There is no mechanism to ensure that a qualified worker is assigned or permitted to pursue an opportunity for which success is likely.

### BRIEF DESCRIPTION OF THE DRAWINGS

The included drawings are for illustrative purposes and serve only to provide examples of possible structures and process operations for one or more implementations of this disclosure. These drawings in no way limit any changes in form and detail that may be made by one skilled in the art without departing from the spirit and scope of this disclosure. A more complete understanding of the subject matter may be derived by referring to the detailed description and claims when considered in conjunction with the following figures, wherein like reference numbers refer to similar elements throughout the figures.

FIG. 1 shows an environment in which opportunity records may be filtered based on user-acquired credentials, according to an implementation of the invention.

FIG. 2A is an example screenshot of opportunities presented to a worker in response to a query without application of the technology disclosed.

FIG. 2B is an example screenshot of opportunities presented with the skill-set based filtering technology disclosed.

FIG. 3A is an example screenshot displayed to the user in response to selecting the “why do I not see all opportunities” button in FIG. 2B.

FIG. 3B is an example screen shot displaying missed opportunities and how to qualify for them.

FIG. 4 shows an example block diagram of a secure opportunity access engine.

FIG. 5 shows an example block diagram of an online skills training/assessment engine.

FIG. 6 illustrates an example flow chart of filtering opportunities in a database accessible to a user, based on system-registered user skills and knowledge.

FIG. 7 illustrates an example block diagram of assembling skill set data and applying filtering to determine which results to return from an opportunities database.

FIG. 8 is an example class diagram of objects in one or more databases used to implement the technology described.

FIG. 9 and FIG. 10 are block diagrams illustrating support of users and user organizations that can be implemented using the technology disclosed.

FIG. 11 is a block diagram of an example computer system on which the software and databases systems described runs.

### DETAILED DESCRIPTION

The following detailed description is made with reference to the figures. Sample implementations are described to illustrate the technology disclosed, not to limit its scope, which is defined by the claims. Those of ordinary skill in the art will recognize a variety of equivalent variations on the description that follows.

The technology disclosed relates to providing skill-based access control to a set of opportunities so that opportunities are only visible to workers with appropriate knowledge and skills. Opportunities to interact with a customer or to provide a service relevant are most successfully pursued by professionals who have demonstrated knowledge and skills with regard to the product or service. Required knowledge and skills for selling or servicing a product or service are referred to herein as skill-based criteria attributes. A particular product or service may require basic, intermediate or advanced skills for a worker to most successfully pursue an opportunity. It may require specific knowledge or skills, as opposed to a general skill level.

System-registered knowledge or skills relevant to a service or product are referred to herein as skill-based credentials and are included in or referenced to a user's profile. Each skill-based criteria attribute corresponds to one or more skill-based credentials that the user of a CRM system must possess to qualify to be presented with an opportunity secured by the skill-based criteria attribute. An opportunity for which a user does not quality may be said to be inaccessible or unavailable to the user. In terms of implementation, having a skill-based credential may allow a user access to view the information in an opportunity record that is protected from access by the corresponding skill-based criteria attribute.

When a user requests a listing of opportunities, the skill-based criteria attributes for each retrieved opportunity in the list are applied to (i.e., compared against) the user's acquired skill-based credentials. In a particular implementation, only opportunities for which the user is qualified (i.e., user has registered skills) are provided to the user in response to a request for opportunities.

In this disclosure, the terms “lead” and “opportunity” are used in their ordinary sense, as understood in the customer relations management (CRM) industry, with the caveat that we sometimes refer to an opportunity inclusive of both leads and opportunities, because the technology disclosed can be applied to either a lead or opportunity. In the CRM art, a “lead” includes a person or organization that has an expressed interest, whose contact information has been captured in a database. In addition, a lead can be an entity in a database that has not expressed interest, but appears has a profile similar to that of another lead or opportunity entity. An “opportunity” is a person or organization that has taken an affirmative action to show the intent and ability to procure a product or service. A qualification process typically converts leads into opportunities. The qualification process can include determining whether a lead has a need for a product or service, that the lead sees value in an offering, that the lead has the financial resources for a deal, that there is access to a decision maker, etc. Since leads or prospects convert into opportunities, the following discussion of applying the technology to “opportunities” generally applies to leads and prospects as well.

Information stored about leads and opportunities can include industry type, market segment, number of employees, customer segment, employee size, product line, service type, stock rate, location, or territory. Additional information may be stored for individuals belonging to an opportunity, referred to as “contacts.” This supplemental information can include names, addresses, job titles, user names, contact information, employer name, etc.

The following user story describes the need for and benefits of an integrated system for optimal assignment of tasks to people.

### User Story

This user story describes implementation of skill-based criteria to filter opportunities presented by a database to a worker, who we will call Jennifer. At first, Jennifer has access to all of the opportunities in the database. When skill-based criteria filtering is implemented, database security uses skill-based criteria to restrict Jennifer's access to opportunities based on her registered skills.

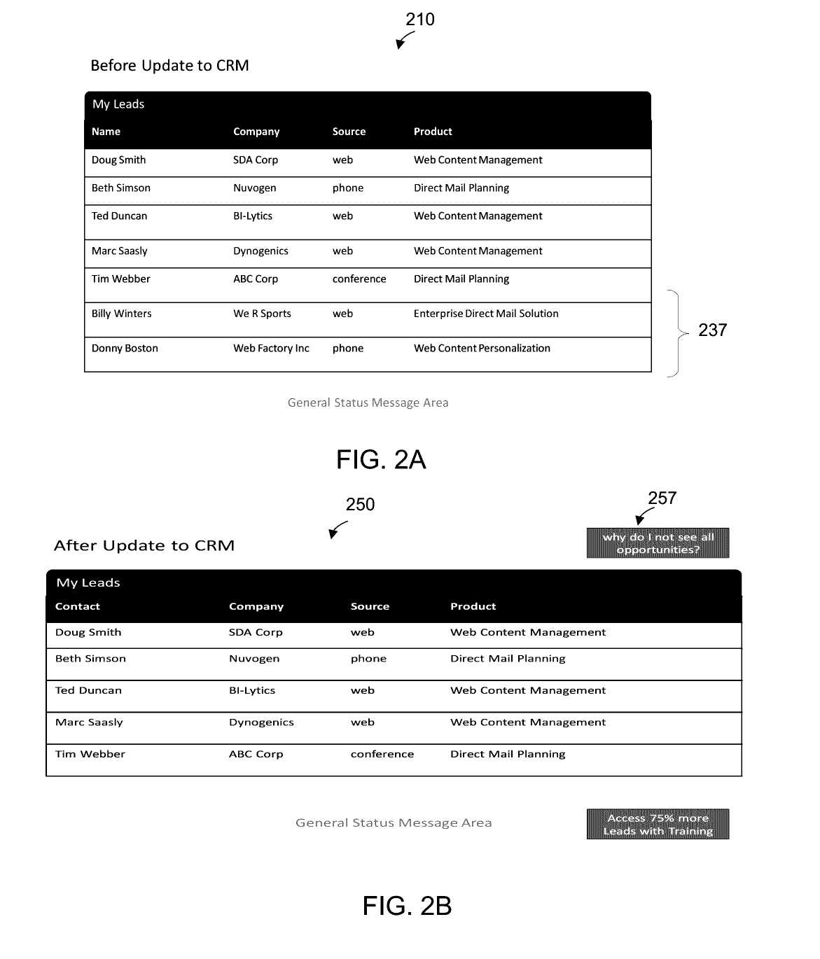

Suppose that Jennifer recently joined the sales team at the marketing software company Interacxion. She is given access to database records representing 10,000 small business accounts and expected to represent a suite of 20 different software products that Interacxion develops. Interacxion's products range from Direct Mail planning software to Web Content Personalization software to be used on websites. Each of these products requires a much different skill set to sell. Due to the variety of skills required, worker performance has historically varied based on the category of customer need and worker expertise around given products. FIG. 2A is an example screenshot of opportunities presented to Jennifer in response to a query before the technology disclosed herein is introduced. Jennifer may see opportunities 210 requiring expertise in Direct Mail Planning and Web Content Management, for which she is qualified, along with other opportunities requiring expertise in Enterprise Direct Mail Solution and Web Content Personalization, for which she is not qualified (237).

To educate the team, Interacxion offers classes, seminars and computer-based training. When representatives (reps) perform their daily calls, they use a CRM system to look up opportunities. Some workers take the initiative to become trained as new products are introduced, but the majority of them feel that by simply calling on more opportunities, they are doing their best to win business.

Jane recently joined Interacxion as the VP of Innovation. She was brought onboard to boost the efficiency in some Interacxion processes, in the hope of the company increasing revenue. Jane interviews a series of reps, and in conversations with Jennifer uncovers that she knows education is important, but does not understand how education serves to make her more efficient, ultimately earning her more commission. She shares with Jane that this dilemma likely creates lost opportunities that could otherwise have been won by another sales rep, because based on their call with Jennifer, prospective customers might not feel she has the right product for them, even when Interacxion's product may actually be ideal for that customer.

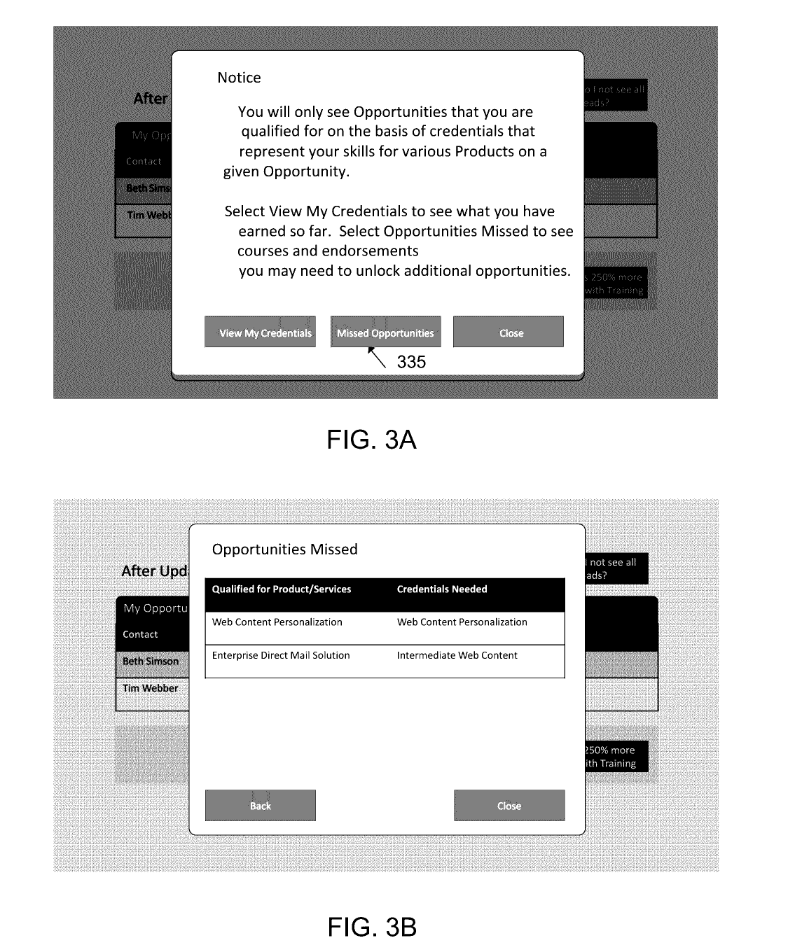

Jane deploys the technology disclosed, which includes an engine that integrates training results with database access management. Once the new technology is introduced, Jennifer logs into her CRM and sees a screen such as presented in FIG. 2B. She notices that the number of opportunities are limited, compared to what she had seen in the past. The only opportunities 250 that she is authorized to access and select are those relevant to areas around which she has registered skills. She clicks on a button 257 labelled “why do I no longer see all opportunities?” at the top of the screen and is presented with an explanation such as seen in FIG. 3A. She then clicks on a button 335 labelled “Missed Opportunities” and is presented, as seen in FIG. 3B, with opportunities that she not presented, for which she reasonably could qualify. It shows the skill sets and credentials needed to qualify for these opportunities. It also can show information about classes, endorsements or other ways to acquire a needed credential.

With the new system in place, Jennifer's efficiency in conversations with opportunity contacts has increased. She is closing a higher percentage of deals and making more commission than before. Additionally, she has enrolled in a class around Web Content Personalization to open up 30% more additional opportunities. Management is pleased with the results, as it takes no additional effort to effectively channel appropriate opportunities to Jennifer, as she registers new skills. Her win rate increases, and she is motivated to gain new skills due to the transparency in how investing their time in developing skill sets affords her new opportunities. Education is no longer separate from access to opportunities. Education and acquiring credentials are transparently coupled by database filters to opportunities in the CRM system.

### System Environment

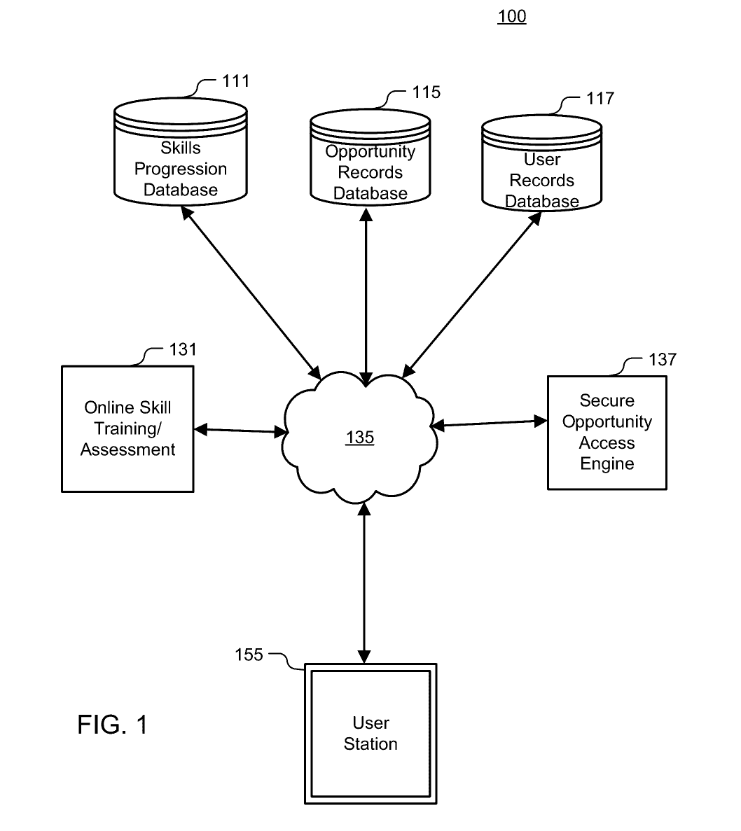

FIG. 1 shows an environment in which opportunity records may be filtered by user-acquired credentials, according to an implementation of the invention. The environment 100 includes a user station 155 through which a user interacts with services over a network 135. Services include Online Skill Training/Assessment 131 and Secure Opportunity Access Engine 137. The services access databases including at least a Skills Progression Database 111, an Opportunity Records Database 115, and a User Records Database 117.

The user station 155 may be a personal computer, laptop computer, tablet computer, smartphone, personal digital assistant (PDA), and the like.

The network 135 may be any one or any combination of Local Area Network (LAN), Wide Area Network (WAN), WiFi, telephone network, wireless network, point-to-point network, star network, token ring network, hub network, or other appropriate configuration of data networks, including the Internet.

The online skill training/assessment service 131 provides online training for users and online testing to certify that a user has acquired a particular skill. Whereas each online training course may have a corresponding certification test, there may be certification tests available for which there is no corresponding online course. Upon a user passing a certification test, the appropriate skill-based credential is added to the appropriate user record in the user records database 117.

Though not shown in FIG. 1, an interface, such as an administrative interface, may populate the opportunity records database 115 with opportunities that are secured by access control information in the form of skill-based criteria attributes. The skill-based criteria attributes identify the user credentials required for a user to qualify for an opportunity assignment. An opportunity record may store or reference contact information and product information. An opportunity record may be accessed for inspection by the system, and the contact information may be provided to a qualified user depending on the criteria attributes securing the one or more products in the opportunity record. A non-qualified user may be presented with product information and access control information without being provided with the contact information. Thus, in an implementation, the opportunity description may be accessible, even when the user is unqualified to pursue the opportunity it contains, but the prospect's contact information and the opportunity record may be inaccessible to the user.

The skills progression database 111 defines progressions of skill sets. A progression of a skill set may include multiple levels of competence such as {level 1, level 2, level 3, level 4} or {beginner, novice, intermediate, expert} or any other progression of skill levels. A progression lists skills in a pre-defined order, such as from low skill level to high skill level. That is, before acquiring a skill in a progression, a user may be required to first acquire the skill earlier in the progression. Each skill level builds on the previous level. Thus, if an opportunity that is secured by a skill-based criteria attribute indicates that a user must be a novice, an intermediate or expert user may also qualify for the opportunity.

The secure opportunity access engine 137 filters a set of opportunity records based on the skill-based criteria attributes that secure each record and compares the attributes against the user's skill-based credentials. In an implementation, the secure opportunity access 137 may retrieve opportunity records from the opportunities records database 115 based on a query from the user. In an alternate implementation, opportunity records may be proactively provided to the secure opportunity access engine. The skill-based criteria attributes used for access control of the opportunity record may be retrieved from within the opportunity record or retrieved based on a reference stored within the opportunity record. In an implementation, the secure opportunity access engine 137 may retrieve a user record from the user records database 119, and in an alternate implementation, a user record or a set of one or more skill-based credentials stored or referenced in the user record may be proactively provided to the secure opportunity access engine 137.

Applying the skill-based criteria attributes to the user's set of one or more skill-based credentials may be implemented in a variety of ways. In one implementation, each skill-based criteria attribute may be mapped to a set of one or more skill-based credentials. If the user has acquired all of the one or more skill-based credentials in the mapped set, then the user may be qualified to access information about the opportunity that is secured by the attribute. Applying the attributes involves verifying that for each attribute of the skill-based criteria attributes, the corresponding sets of user credentials are stored in or referenced by the user record. For example, the skill-based criteria attribute “Basic Inbound Marketing” is satisfied when the corresponding skill-based credential “Value of Blogging Video” is in the user's profile.

For skill sets that are represented as a progression, applying the attributes may involve verifying that each attribute representing a skill level in a progressive skill set is associated with a user credential that is at least as high or higher in the skill set progression. For example, a user having an intermediate skill level may satisfy a requirement for an attribute representing a novice skill level in the same skill progression, but a user having a beginner skill level may not be qualified.

### Secure Opportunity Access Engine

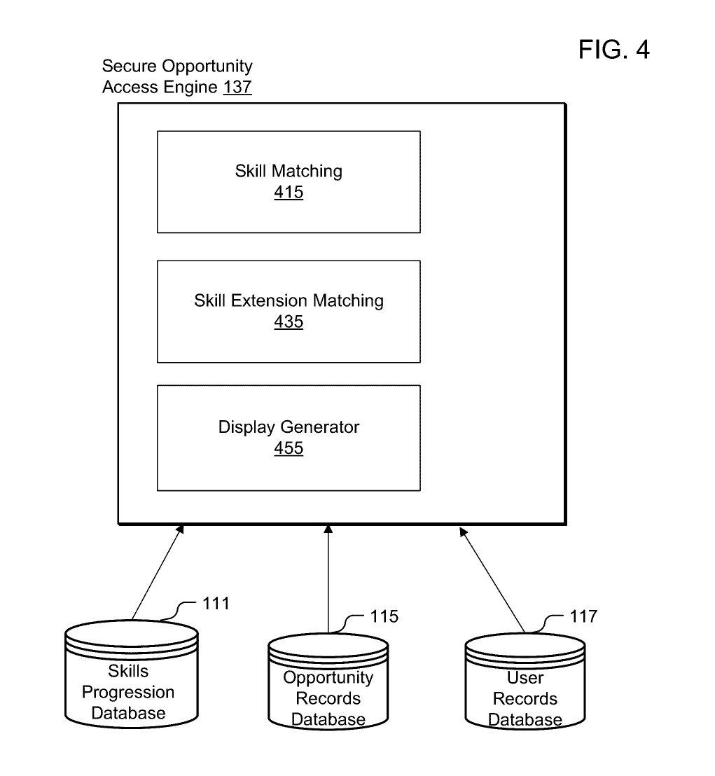

FIG. 4 shows an example block diagram of a secure opportunity access engine. The secure opportunity access engine 137 may comprise a Skill Matching module 415, a Skill Extension Matching module 435, and a Display Generator 455. The skill matching module 415 performs the application of skill-based criteria attributes to user's skill-based credentials to determine whether the user should be granted access to an opportunity that is secured by the attributes. Implementations of the skill matching module 415 are described above.

The skill extension matching module 435 allows a user to view opportunities for which they are not currently qualified but could become qualified if additional identified skill-based credentials were to be acquired. The goal is to identify and prioritize skill acquisition based on how many and which additional opportunities would become accessible to the user. For at least one opportunity for which the user is not qualified to access, the set of missing/lacking user credentials is determined. That is, the missing user credentials are those needed in addition to the credentials the user has already acquired in order to qualify to access the opportunity.

One or more currently inaccessible opportunities may be selected from the set of all opportunities requested by the user based on information about the missing user credentials. In an implementation, all opportunities may be selected for which there is at most one missing user credential missing from the user profile. In another implementation, a configured maximum number of currently inaccessible opportunities may be selected based on sorting the currently inaccessible opportunities by the number of missing credentials, and selecting those opportunities with the least missing credentials.

In an implementation, for each selected inaccessible opportunity, one or more training or skill demonstration options may be identified as leading to the acquisition of the one or more missing user credentials.

The display generator module 455 prepares data for transmission to the user station 155 in response to the user's query. In an implementation, only data regarding accessible opportunities may be prepared for transmission to the user. In another implementation, data regarding currently inaccessible opportunities and the corresponding training opportunities that would make these opportunities accessible may also be prepared for transmission to the user.

### Online Skills Training/Assessment Module

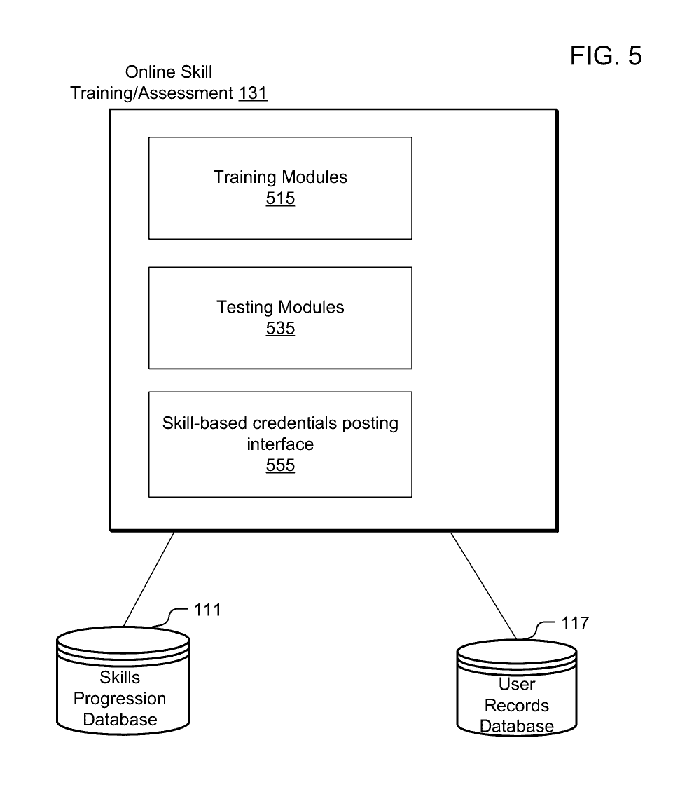

FIG. 5 shows a block diagram of an online skills training/assessment module, according to an implementation of the invention. The online skills training/assessment module comprises Training Modules 515, Testing Modules 535, and Skill-based credentials posting interface 555. The training modules 515 provide online training for users that impart knowledge needed by users to sell or service one or more products. Testing Modules 535 provide online testing. A particular skill-based credential may be acquired by a user by passing an online test. An online test may test knowledge taught in an online training class. Alternatively, an online test may test knowledge obtained through means other than an online training class.

The skill-based credentials posting interface 555 includes a programmatic interface for updating a user's record in the user records database to add a credential verified by an online test. The user records database may be updated automatically and immediately upon successful test completion. In an implementation, the user record may be updated while the user waits for the test results or successful training completion indication or upon the user exiting from the online test session or class. That is, when a user passes an online test, no manual intervention is necessary for the user's record to store or refer to the credential that was newly acquired by passing the online test. In an alternate implementation, the system may automatically add credentials into a user's record upon receiving a notification from a trusted source outside the integrated system. For example, if a peer endorses a user for a skill on LinkedIn, a utility tool may receive/retrieve the endorsement and invoke the programmatic interface for entering a new credential into the user record database.

### Flowchart of Filtering Opportunities Based on Skill Set

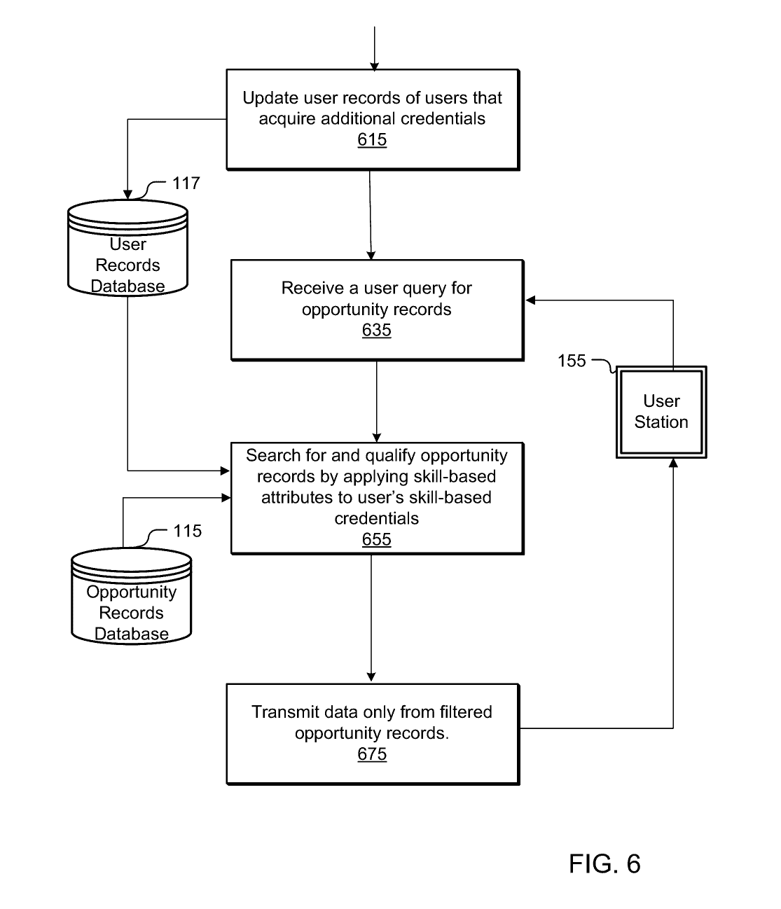

FIG. 6 illustrates a flow chart of providing opportunities to a user that are filtered based on the user demonstrating required skills and knowledge, according to an implementation of the invention. In Step 615, a record in the user records database 117 is updated to add a new skill-based credential. This step may happen at any time in the flow. In Step 635, a query is received from the user station 155 that requests a list of opportunities based on some filters. For example, a user may request all opportunities for a certain customer, for a particular product or service, for a certain geographical area, etc. In Step 655, the query is processed. Skill-based credentials are retrieved for the user. Opportunity records for opportunities satisfying the user query are retrieved and qualified for user access based on applying the skill-based attributes securing the opportunity record to the user's skill-based credentials. In Step 675, only data regarding opportunities that are qualified for the user are prepared for transmission to the user station in response to the query. The transmitted data may be displayed to the user by the user station. In an alternate implementation, product information from opportunities for which the user is not qualified may be prepared for transmission along with information on the additional necessary credentials needed to qualify for each opportunity and guidance regarding how to acquire the additional necessary credentials. In an implementation, a subset of all of the opportunities for which the user is not qualified may be transmitted, where the subset is selected based on the relative ease of acquiring the necessary credentials. For example, opportunities for which a user would be qualified after acquiring one additional credential may be selected. As another example, the opportunities may be ranked in order of effort required to obtain necessary credentials to qualify, and a certain number or proportion of the top ranked opportunities may be selected for transmission.

### Sources of Skill-Based Credentials

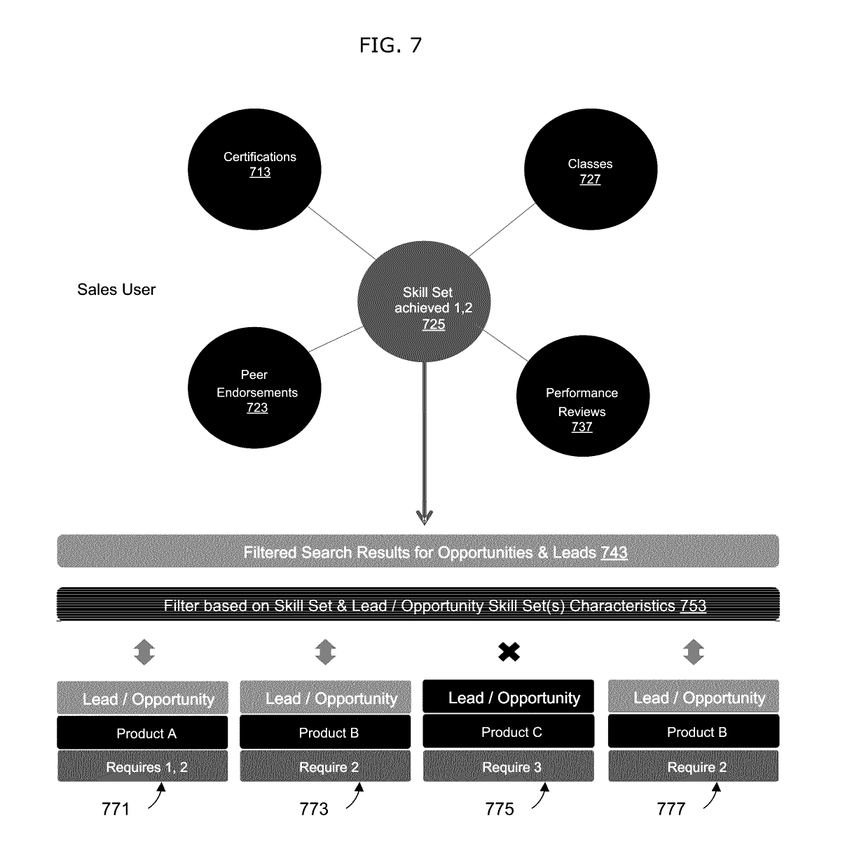

FIG. 7 illustrates an example of obtaining filtered opportunities based on various sources for demonstrating knowledge and skills for credential acquisition, according to an implementation of the invention. In this example, a user has acquired credentials for skill sets 1 and 2 as seen in 725. Sources of such user credentials may come from certifications 713 such as passing an online test not associated with a particular online class, from completing an online class 727, from peer endorsements 723, such as endorsement from social media like LinkedIn, and from a performance review 737. The user searches for opportunities. There are four opportunity records that satisfy the user's query. Opportunity 771 is an opportunity to sell product A that requires credentials for skill sets 1 and 2. Opportunity 773 is an opportunity to sell Product B that requires a credential for skill set 2. Opportunity 775 is an opportunity to sell Product C that requires a credential for skill set 3. And Opportunity 777 requires a credential for skill set 2. A filter 753 filters the four opportunities that satisfy the user's query based on the skill-based access control by comparing the user credentials against the required skill sets. The filtered list of opportunities 743 is provided to the user. The user, having acquired credentials for skill sets 1 and 2, qualifies for opportunities 771, 773, and 777, but does not qualify for opportunity 775 that requires a credential for skill set 3 that the user has not acquired. Thus, a filtered view including opportunities 771, 773, and 777 may be provided to the user.

Data Structures for Matching a Skill-Based Attribute with Credentials

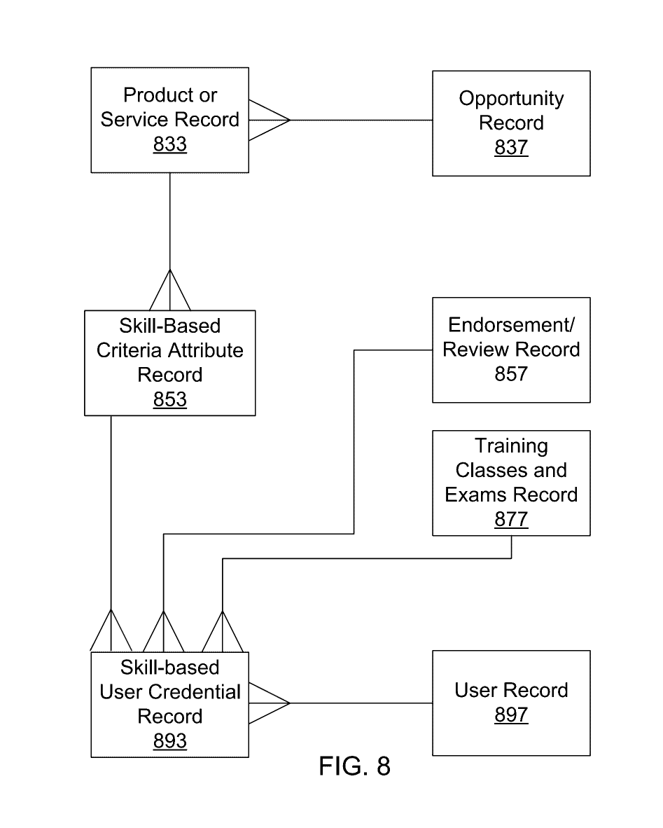

FIG. 8 is a block diagram illustrating the relationships among entities stored in one or more data structures, according to an implementation. An opportunity record 837 provides information about opportunities to sell or service a product to/for a customer. In addition to providing information about the customer, the opportunity record provides an indication of which product the customer is considering purchasing or for which service is requested. There may be a one-to-one or a one-to-many correspondence between opportunities and products. That is, in an implementation, one opportunity record may represent an opportunity to sell or service multiple products or services stored in Product or Service Records 833.

A Product or Service record 833 provides information about a product or service to sell. Information about a product or service may be associated with one or more skill-based criteria attributes that may be used to control access to opportunity records associated with the product or service. A Product or Service Record 833 may refer to one or more Skill-based Criteria Attribute Records 853, according to an implementation. Each skill-based criteria attribute corresponds to one or more skill-based credentials that the user must have acquired in order to satisfy the corresponding skill-based criteria attribute. The skill-based criteria attribute record 853 may refer to one or more Skill-based User Credential Records 893. Each user credential may be associated with one or more resources for acquiring the credential. For example, a credential may be offered to the user after completing a training class, passing an exam, or receiving an endorsement. A skill-based user credential record 893 may store or refer to a Training Classes and Exams Record 877 or Endorsement/Review Record 857.

A User Record 897 stores user profile information for a sales or service representative. In addition to other information about a user, the user record provides information about the user's acquired credentials. A user record 897 may store or refer to one or more skill-based user credential records 893.

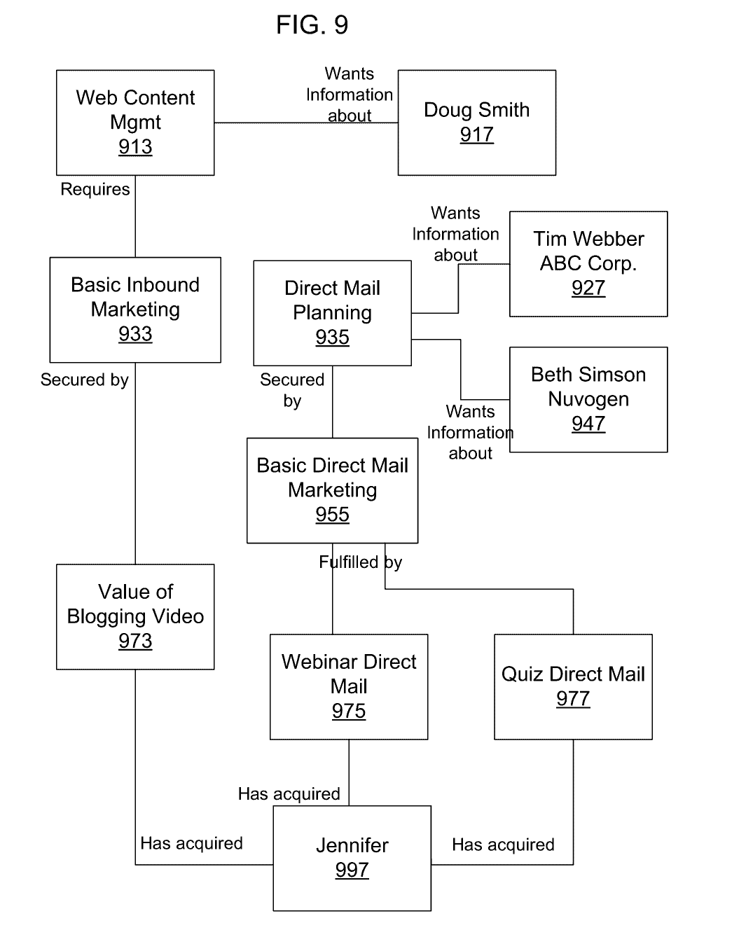

FIG. 9 provides an entity relationship diagram for the example user story showing entity relationships for opportunities that user Jennifer 997 is qualified to pursue. Jennifer 997 has acquired credentials for “Value of Blogging Video” 973, “Webinar Direct Mail” 975, and “Quiz Direct Mail” 977. Opportunity record 917 represents Doug Smith's request for information regarding the Web Content Mgmt product 913. Selling or servicing the Web Content Mgmt 913 product is secured by a Basic Inbound Marketing 933 skill-based attribute that is fulfilled by Value of Blogging Video 973. Because Jennifer has acquired Value of Blogging Video 973, she is qualified pursue Doug Smith's opportunity.

Similarly, Tim Webber from ABC Corp 927 and Beth Simson of Nuvogen 947 both want information about a Direct Mail Planning 935 product. The Direct Mail Planning 935 product is secured by Basic Direct Mail marketing 955 skill-based criteria attribute. The attribute is fulfilled by having both the Webinar Direct Mail 975 user credential and the Quiz Direct Mail 977 user credential, both of which Jennifer has acquired. Thus, Jennifer is qualified to pursue Tim Webber's and Beth Simson's opportunity.

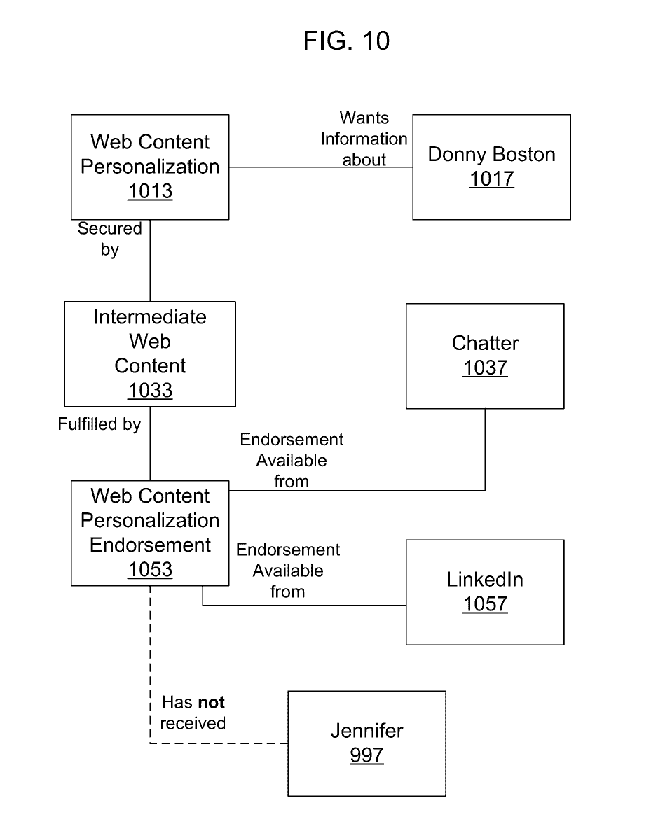

FIG. 10 illustrates the entity relationships used in determining missed opportunities and determining how the missing credentials may be obtained. Donny Boston 1017 wants information about the Web Content Personalization 1013 product. Selling or servicing this product requires expertise, and thus is secured by, the Intermediate Web Content 1033 criteria attribute. The attribute may be satisfied if the user has acquired the Web Content Personalization Endorsement 1053 credential. However, user Jennifer 997 has not yet acquired the Web Content Personalization Endorsement 1053 credential. However, if Jennifer wants to pursue opportunities such as Donny Boston, she may obtain the credential by receiving an endorsement from a colleague, client, or other professional associate using Chatter 1037 or LinkedIn 1057.

### Computer System

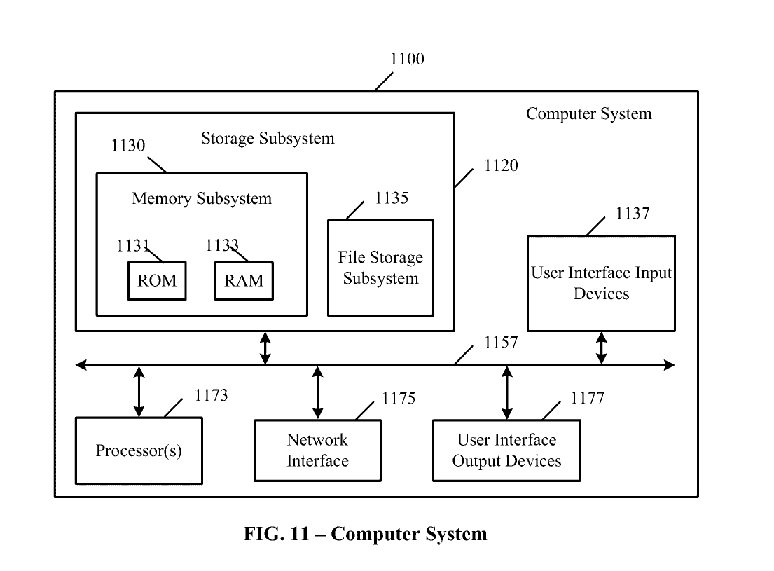

FIG. 11 is a block diagram of an example computer system 1100 for personalizing skill-set based CRM engagements, according to one implementation. Computer system 1100 typically includes at least one processor 1173 that communicates with a number of peripheral devices via bus subsystem 1157. These peripheral devices can include a storage subsystem 1120 including, for example, memory devices and a file storage subsystem, user interface input devices 1137, user interface output devices 1177, and a network interface subsystem 1175. The input and output devices allow user interaction with computer system 1100. Network interface subsystem 1175 provides an interface to outside networks, including an interface to corresponding interface devices in other computer systems.

User interface input devices 1137 can include a keyboard; pointing devices such as a mouse, trackball, touchpad, or graphics tablet; a scanner; a touch screen incorporated into the display; audio input devices such as voice recognition systems and microphones; and other types of input devices. In general, use of the term “input device” is intended to include all possible types of devices and ways to input information into computer system 1100.

User interface output devices 1177 can include a display subsystem, a printer, a fax machine, or non-visual displays such as audio output devices. The display subsystem can include a cathode ray tube (CRT), a flat-panel device such as a liquid crystal display (LCD), a projection device, or some other mechanism for creating a visible image. The display subsystem can also provide a non-visual display such as audio output devices. In general, use of the term “output device” is intended to include all possible types of devices and ways to output information from computer system 1100 to the user or to another machine or computer system.

Storage subsystem 1120 stores programming and data constructs that provide the functionality of some or all of the modules and methods described herein. These software modules are generally executed by processor 1173 alone or in combination with other processors.

Memory subsystem 1130 used in the storage subsystem can include a number of memories including a main random access memory (RAM) 1133 for storage of instructions and data during program execution and a read only memory (ROM) 1131 in which fixed instructions are stored. A file storage subsystem 1135 can provide persistent storage for program and data files, and can include a hard disk drive, a floppy disk drive along with associated removable media, a CD-ROM drive, an optical drive, or removable media cartridges. The modules implementing the functionality of certain implementations can be stored by file storage subsystem 1135 in the storage subsystem 1120, or in other machines accessible by the processor.

Bus subsystem 1157 provides a mechanism for letting the various components and subsystems of computer system 1100 communicate with each other as intended. Although bus subsystem 1157 is shown schematically as a single bus, alternative implementations of the bus subsystem can use multiple busses.

Computer system 1100 can be of varying types including a workstation, server, computing cluster, blade server, server farm, or any other data processing system or computing device. Due to the ever-changing nature of computers and networks, the description of computer system 1100 depicted in FIG. 11 is intended only as one example. Many other configurations of computer system 1100 are possible having more or fewer components than the computer system depicted in FIG. 11.

### Particular Implementations

In one implementation, a method is described from the perspective of a server system receiving messages from a user station. The system provides a database of opportunity records, each of which relates to a particular product or service and is secured by one or more skill-based criteria attributes. Each skill-based criteria attribute corresponding to one or more skill-based credentials that a user must acquire to qualify the user to sell or service the particular product or service. The system also provides a database of user records, each of which provides one or more skill-based credentials for selling or servicing products or services. Upon the server determining that a user has acquired an additional skill-based credential, the server adds the additional skill-based credential to a user record associated with the user. Upon the server receiving a query for a list of desired opportunities, the server may access one or more skill-based credentials, applicable to the query. The credentials may be cached or they may be retrieved from the user record in which they are stored or retrieved from where they are stored based on a reference stored in the user record. The server retrieves opportunity records that satisfy the user query. For each retrieved opportunity record, the server applies the skill-based criteria attributes that secure the opportunity record to the relevant skill-based user credentials to determine whether the user is qualified to access the opportunity. In one implementation, the server only transmits data from opportunity records for which the user is qualified.

In an implementation, applying skill-based criteria attributes to the user credentials involves matching up each attribute with the corresponding one or more credentials. If there is an attribute for which corresponding credentials have not been acquired by the user, then the user is not qualified to pursue the opportunity, and access is denied to the opportunity record. In another implementation, a skill-based criteria attribute may be defined by a progression of skill levels. In that case, applying skill-based criteria attributes to the user credentials involves determining for each level of skill specified by a skill-based criteria attribute whether the user credentials represent at least the skill level specified by the attribute. The credential may not exactly match the attribute. The user credential may represent a higher skill level in the same skill progression as the attribute.

User credentials may be earned in a variety of ways. For example, the user may complete a training class, management of the company may award a credential based on demonstrated performance, a peer may endorse the user for a skill (similar to endorsements on LinkedIn) or a user may pass a competency test. However a credential is earned, the credential may be automatically added to the user's record in the user record database 117. In an implementation, the online training class, examination, or performance review may update the user record without any human intervention.

In an implementation, at least one opportunity record representing an opportunity that is unavailable to the user is identified. Also identified are one or more skill-based credentials that the user has not yet acquired that prevent the opportunities from being available to the user, and one or more training opportunities leading to acquisition of the one or more lacking skill-based credentials. An indication of the opportunity, the one or more lacking skill-based credentials, and the one or more training opportunities are transmitted for display to the user. After the user completes the necessary training, the user may become qualified to access the previously inaccessible portion of an opportunity record.

In an implementation, the one or more opportunities identified, for which the user is not qualified to access, are selected based on the user only lacking one skill-based credential.

In an implementation, the skill-based criteria attributes comprise a hierarchy of skills, wherein qualification of a skill at a parent level in the hierarchy qualifies a user for any skill-based criteria under the parent level. For example, if a prerequisite to obtaining credential A is that the user first acquire both credentials B and C, then a skill-based criteria attribute corresponding to credential A may be used as a short-hand way to express requiring both credentials B and C. In another implementation, a skill-based criteria attribute comprises a progression of skill levels such that the lowest level skill appears first in the progression, and subsequent skill levels build on the skill levels preceding it in the progression. Thus, once a credential is earned for a particular skill level in a progression, the credential satisfies skill-based criteria attributes for skills at a lower level in the same progression.

Other implementations of the technology may include a non-transitory computer-readable storage medium storing instructions, which when executed, perform any of the methods described above. Yet another implementation of the technology may include a system comprising one or more processors coupled to a memory device such that the one or more processors are configured to execute instructions stored on the non-transitory computer-readable storage medium described previously.

A system implementation may include a skill-progression database containing records that define a progression of skill-based criteria attributes, an opportunities database containing records that define opportunities secured by one or more skill-based criteria attributes, and a user database containing user records wherein each user record represents a particular user, and said each user record provides one or more skill-based credentials acquired by the particular user. Additionally, the system may include an online skill training and assessment module that is configured to validate for a user acquisition of a new skill-based credential and adds the new skill-based credential to the user's user record, and a secure opportunity access engine that is configured to apply skill-based criteria attributes that secure an opportunity to skill-based credentials provided the particular user.

Another implementation of the disclosed technology is a secure opportunity access engine apparatus that comprises a skill matching module configured to qualify one or more opportunities for a user by applying skill-based criteria attributes that secure each of the one or more opportunities to skill-based credentials acquired by the user, and a display generator configured to generate display data for a qualified opportunity. The secure opportunity access engine may be implemented to further include a skill extension module for determining unqualified opportunities and lacking skill-based credentials that are required for access to the unqualified opportunities and not yet acquired by the user. The access engine may be further configured to generate display data for an unqualified opportunity and associated lacking skill-based credentials.

While the present technology is disclosed by reference to examples detailed above, it is to be understood that these examples are intended in an illustrative rather than in a limiting sense. It is contemplated that modifications and combinations will readily occur to those skilled in the art, which modifications and combinations will be within the spirit of the technology and the scope of the following claims.

1. A computer-implemented method, including:
providing a database of opportunity records, wherein each opportunity record relates to a particular product or service and is secured by one or more skill-based criteria attributes, each skill-based criteria attribute corresponding to one or more skill-based credentials that a user must have to qualify the user to sell or service the particular product or service;
providing a database of user records, wherein at least one user record provides one or more skill-based credentials for selling or servicing products or services;
responsive to a user acquiring additional skill-based credentials adding the additional skill-based credentials to a user record associated with the user;
receiving a query for opportunity records;
accessing one or more skill-based credentials, applicable to the query, that are stored or referenced in the user record;
qualifying opportunity records retrieved in response to the query by applying the skill-based criteria attributes to the applicable one or more skill-based credentials; and
transmitting data only from the qualified opportunity records in response to the query.

2. The method of claim 1, wherein applying skill-based criteria attributes to the applicable one or more skill-based credentials comprises determining for each skill-based criteria attribute of the skill-based criteria attributes that the corresponding one or more skill-based credentials are included in the user record associated with the user.

3. The method of claim 1, wherein the skill-based credentials are automatically updated upon completion of an online course, and the skill-based criteria attributes include completion of the online course as a qualification to access opportunity records for one or more products or services.

4. The method of claim 1, wherein the skill-based credentials are automatically updated upon completion of an objective skill evaluation of the user by management.

5. The method of claim 1, wherein the skill-based credentials are automatically updated based upon scoring of peer endorsements of the user regarding one or more skills related to the particular product or service.

6. The method of claim 1, wherein the skill-based credentials are automatically updated upon completion of an online certification examination, and the skill-based criteria attributes include completion of the online certification as a qualification to access opportunities for one or more products or services.

7. The method of claim 1, further including:
identifying:
at least one opportunity record representing an opportunity that is unavailable to the user;
one or more lacking skill-based credentials not yet acquired by the user that are required to qualify the user for access to the opportunity;
one or more training opportunities leading to acquisition of the one or more lacking skill-based credentials;
transmitting for display to the user an indication of the opportunity, the one or more lacking skill-based credentials, and the one or more training opportunities; and
responsive to the user completing the indicated one or more training opportunities, the user becoming qualified to access the opportunity that was previously inaccessible.

8. The method of claim 1, further including:
identifying one or more opportunities stored or referenced by opportunity records secured by a first plurality of skill-based criteria attributes for which the user has acquired all but one lacking skill-based credential corresponding to the first plurality of skill-based criteria attributes; and
transmitting for display to the user the identified one or more opportunities and the corresponding one lacking skill-based credential.

9. The method of claim 1, the skill-based criteria attributes comprising a hierarchy of skills, wherein qualification of a skill at a parent level in the hierarchy qualifies a user for any skill-based criteria under the parent level.

10. The method of claim 1, further including a skill-based criteria attribute comprising a progression of skill levels; and wherein:
a skill level farther along in the progression of skill levels is a higher level of the skill-based criteria attribute than a skill level earlier in the progression; and
qualification of a higher skill level qualifies a user for any lower-level of the skill-based criterion.

11. A non-transitory computer-readable storage medium storing instructions, which when executed by a processor, cause the processor to:
access a database of opportunity records, wherein each opportunity record relates to a particular product or service and is secured by one or more skill-based criteria attributes, each skill-based criteria attribute corresponding to one or more skill-based credentials that a user must have to qualify the user to sell or service the particular product or service;
access a database of user records, wherein at least one user record provides one or more skill-based credentials for selling or servicing products or services;
responsive to a user acquiring additional skill-based credentials, add the additional skill-based credentials to a user record associated with the user;
receive a query for opportunity records;
access one or more skill-based credentials, applicable to the query, that are stored or referenced in the user record;
qualify opportunity records retrieved in response to the query by applying the skill-based criteria attributes to the applicable one or more skill-based credentials; and
transmit data only from the qualified opportunity records in response to the query.

12. The non-transitory computer-readable storage medium of claim 11, wherein applying skill-based criteria attributes to the applicable one or more skill-based credentials comprises determining for each skill-based criteria attribute of the skill-based criteria attributes that the corresponding one or more skill-based credentials are included in the user record associated with the user.

13. The non-transitory computer-readable storage medium of claim 11, wherein the skill-based credentials are automatically updated upon completion of an online course, and the skill-based criteria attributes include completion of the online course as a qualification to access opportunity records for one or more products or services.

14. The non-transitory computer-readable storage medium of claim 11, wherein the skill-based credentials are automatically updated upon completion of an objective skill evaluation of the user by management.

15. The non-transitory computer-readable storage medium of claim 11, wherein the skill-based credentials are automatically updated based upon scoring of peer endorsements of the user regarding one or more skills related to the particular product or service.

16. A system comprising:
one or more processors coupled to a memory device; and
the one or more processors configured to execute instructions stored on a non-transitory computer-readable storage medium, the instructions which when executed by the one or more processors, cause the one or more processors to:
access a database of opportunity records, wherein each opportunity record relates to a particular product or service and is secured by one or more skill-based criteria attributes, each skill-based criteria attribute corresponding to one or more skill-based credentials that a user must have to qualify the user to sell or service the particular product or service;
access a database of user records, wherein at least one user record provides one or more skill-based credentials for selling or servicing products or services;
responsive to a user acquiring additional skill-based credentials, add the additional skill-based credentials to a user record associated with the user;
receive a query for opportunity records;
access one or more skill-based credentials, applicable to the query, that are stored or referenced in the user record;
qualify opportunity records retrieved in response to the query by applying the skill-based criteria attributes to the applicable one or more skill-based credentials; and
transmit data only from the qualified opportunity records in response to the query.

17. The system of claim 16, further including:
a skill-progression database containing records that define a progression of skill-based criteria attributes;
an opportunities database containing records that define opportunities secured by one or more skill-based criteria attributes;
a user database containing user records wherein each user record represents a particular user, and said each user record provides one or more skill-based credentials acquired by the particular user;
an online skill training and assessment module that is configured to validate for a user acquisition of a new skill-based credential and adds the new skill-based credential to the user's user record; and
a secure opportunity access engine that is configured to apply skill-based criteria attributes that secure an opportunity to skill-based credentials provided the particular user.

18. The system of claim 16, wherein the skill-based credentials are automatically updated upon completion of an online certification examination, and the skill-based criteria attributes include completion of the online certification as a qualification to access opportunities for one or more products or services.

19. The system of claim 16, the non-transitory computer-readable storage medium further storing instructions which when executed cause the one or more processors to:
identify:
at least one opportunity record representing an opportunity that is unavailable to the user;
one or more lacking skill-based credentials not yet acquired by the user that are required to qualify the user for access to the opportunity; and
one or more training opportunities leading to acquisition of the one or more lacking skill-based credentials;
transmit for display to the user an indication of the opportunity, the one or more lacking skill-based credentials, and the one or more training opportunities; and
responsive to the user completing the indicated one or more training opportunities, qualify the user to access the opportunity that was previously inaccessible.

20. The system of claim 16, the non-transitory computer-readable storage medium further storing instructions which when executed, cause the one or more processors to:
identify one or more opportunities stored or referenced by opportunity records secured by a first plurality of skill-based criteria attributes for which the user has acquired all but one lacking skill-based credential corresponding to the first plurality of skill-based criteria attributes; and
transmit for display to the user the identified one or more opportunities and the corresponding one lacking skill-based credential.

21. The system of claim 16, the skill-based criteria attributes comprising a hierarchy of skills, wherein qualification of a skill at a parent level in the hierarchy qualifies a user for any skill-based criteria under the parent level.

22. A secure opportunity access engine apparatus, comprising:
a skill matching module configured to qualify one or more opportunities for a user by applying skill-based criteria attributes that secure each of the one or more opportunities to skill-based credentials acquired by the user; and
a display generator configured to generate display data for a qualified opportunity.

23. The secure opportunity access engine apparatus of claim 22, further comprising:
a skill extension module for determining unqualified opportunities and lacking skill-based credentials that are required for access to the unqualified opportunities and not yet acquired by the user; and
wherein the display generator is further configured to generate display data for an unqualified opportunity and associated lacking skill-based credentials.

24. The secure opportunity access engine apparatus of claim 22 further including the skill-based criteria attributes comprising a hierarchy of skills, wherein qualification of a skill at a parent level in the hierarchy qualifies a user for any skill-based criteria under the parent level.

25. The secure opportunity access engine apparatus of claim 22, further including a skill-based criteria attribute comprising a progression of skill levels; and wherein:
a skill level farther along in the progression of skill levels is a higher level of the skill-based criteria attribute than a skill level earlier in the progression; and
qualification of a higher skill level qualifies a user for any lower-level of the skill-based criterion.
